(19) United States
(12) Patent Application Publication
(10) Pub. No.: US 2022/0182819 A1
(43) Pub. Date: Jun. 9, 2022

(54) MULTIMEDIA CONTROL APPARATUS AND METHOD FOR A VEHICLE

(71) Applicants: HYUNDAI MOTOR COMPANY, Seoul (KR); KIA CORPORATION, Seoul (KR)

(72) Inventors: Seong Soo Yae, Hwaseong-si (KR); Seo Hwan Choi, Seoul (KR); Hyun Woo Lee, Seoul (KR); Jeong Won Lee, Suwon-si (KR)

(73) Assignees: HYUNDAI MOTOR COMPANY, Seoul (KR); KIA CORPORATION, Seoul (KR)

(21) Appl. No.: 17/516,336

(22) Filed: Nov. 1, 2021

(30) Foreign Application Priority Data
Dec. 9, 2020 (KR) 10-2020-0171731

(51) Int. Cl. H04W 12/02; B60N 2/00; H04W 4/48; H04W 12/06; H04W 12/63; H04W 12/0431

(52) U.S. Cl. CPC H04W 12/02; B60N 2/002; H04W 4/48; B60R 22/48; H04W 12/63; H04W 12/0431; H04W 12/06

(57) ABSTRACT

A multimedia control apparatus and a multimedia control method for a vehicle are disclosed. The multimedia control apparatus includes a sensing device that detects a terminal position and a seat seating position in the vehicle when an open door of the vehicle is sensed; a position searcher that determines a position of a rear seat passenger based on the terminal position and the seat seating position; and a controller that controls a privacy mode operation of a rear seat multimedia device based on the position of the rear seat passenger.

### CROSS-REFERENCE TO RELATED APPLICATION

This application claims the benefit of priority to Korean Patent Application No. 10-2020-0171731, filed in the Korean Intellectual Property Office on Dec. 9, 2020, the entire contents of which are incorporated herein by reference.

### TECHNICAL FIELD

The present disclosure relates to a multimedia control apparatus for a vehicle and a method of the same.

### BACKGROUND

In general, an infotainment system for a vehicle is a system that integrates information, which means information necessary for driving, such as road guidance, and entertainment, which means entertainment and human-friendly functions.

The infotainment system for a vehicle is implemented in the form of multimedia player equipped with complex functions such as music or video file playback, games, and broadcast reception as functions are diversified.

In addition, the infotainment system for a vehicle is wirelessly connected to a mobile terminal such as a smartphone to exchange various information or may also provide various data or information to a vehicle occupant depending on an acoustic form, a visual form, or a combination thereof.

Recently, although exposure of personal information is considered to be socially sensitive, the conventional infotainment systems for a vehicle do not consider independence of information of rear seat passengers. For example, when a VIP passenger rides in a rear seat of a vehicle, a privacy service for the rear seat passenger is not specially provided, although the VIP passenger attaches great importance to information security.

### SUMMARY

The present disclosure has been made to solve the above-mentioned problems occurring in the prior art while advantages achieved by the prior art are maintained intact.

An aspect of the present disclosure provides a multimedia control apparatus and a method for a vehicle, which prevent a privacy of a rear seat passenger from leaking to other occupants and provide independence by controlling an operation of a rear seat multimedia device in a privacy mode based on the rear seat passenger.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a multimedia control apparatus includes: a sensing device that detects a terminal position and a seat seating position in the vehicle when an open door of the vehicle is sensed; a position searcher that determines a position of a rear seat passenger based on the terminal position and the seat seating position; and a controller that controls a privacy mode operation of a rear seat multimedia device based on the position of the rear seat passenger.

In an embodiment, the sensing device may include a sensor that scans a terminal in the vehicle using a wireless communication method and detects at least one or more terminal information and position information.

In addition, according to an aspect of the present disclosure, a multimedia control apparatus may further include an authenticator that authenticates the terminal by comparing the terminal information with information of a previously registered user terminal.

In an embodiment, the controller may allow the rear seat multimedia device to operate in a privacy mode based on setting of the privacy mode stored in the terminal, when the authentication of the terminal is completed.

In an embodiment, the controller may allow the rear seat multimedia device to operate in a privacy mode based on setting of the privacy mode input through the terminal or a monitor of the rear seat multimedia device, when the authentication of the terminal is completed.

In an embodiment, the sensing device may include at least one or more of a sensor disposed at a lower end of each seat to detect a change in weight, a sensor disposed at the lower end or a back of each seat to detect a temperature change, or a sensor to detect a belt fastener state at each seat position.

In an embodiment, the sensing device may include a sensor that detects a state of the open door of the vehicle.

In an embodiment, the position searcher may determine the position of the rear seat passenger based on the terminal position, the seat seating position, and a position of the open door.

In an embodiment, the controller may determine the position of the rear seat passenger based on a priority of each position, when at least one or more of the terminal position, the seat seating position, or the position of the open door is different.

In an embodiment, the controller may determine the position of the rear seat passenger by preferentially considering the seat seating position among the terminal position, the seat seating position, and the position of the open door.

In an embodiment, the position searcher may re-measure the terminal position based on the position of the rear seat passenger when the position of the rear seat passenger is determined. The position searcher may update the terminal position when the re-measured terminal position is different from a previously detected terminal position.

In an embodiment, the position searcher may determine a final position of the rear seat passenger based on the updated terminal position.

In an embodiment, the position searcher may detect a position of a digital key to predict an open position of a boarding door, when an approach of the digital key is detected within a predetermined distance from the vehicle.

In an embodiment, when the controller is wirelessly connected to the digital key approaching from a vicinity of the vehicle, the controller may activate at least one or more sensors included in the sensing device.

In an embodiment, the rear seat multimedia device may display call receiving information on a rear seat monitor at the position of the rear seat passenger without outputting an incoming call sound through a vehicle speaker when an incoming call is received in a setting state of a privacy mode. The rear seat multimedia device may connect a call to the terminal of the rear seat passenger through hands-free when an active call is connected.

In an embodiment, the controller may limit operation information of the rear seat multimedia device, which is displayed on a monitor of a front seat multimedia device, when the rear seat multimedia device operates in a privacy mode.

In an embodiment, the controller may release the privacy mode of the rear seat multimedia device, when a phone projection connection is performed through the front seat multimedia device while the rear seat multimedia device operates in the privacy mode.

In addition, according to an aspect of the present disclosure, a multimedia control method for a vehicle includes: detecting a terminal position and a seat seating position in the vehicle when an open door of the vehicle is sensed; determining a position of a rear seat passenger based on the terminal position and the seat seating position; and controlling a privacy mode operation of a rear seat multimedia device based on the position of the rear seat passenger.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram illustrating a vehicle system to which a multimedia control apparatus for a vehicle according to an embodiment of the present disclosure is applied;

FIG. 2 is a diagram illustrating a configuration of a multimedia control apparatus for a vehicle according to an embodiment of the present disclosure;

FIGS. 3A-3M are diagrams illustrating an embodiment referenced to describe an operation of a multimedia control apparatus for a vehicle, according to an embodiment of the present disclosure;

FIGS. 4, 5 and 6 are diagrams illustrating an operation flow for a multimedia control method for a vehicle according to an embodiment of the present disclosure; and

FIG. 7 is a diagram illustrating a computing system in which a method according to an embodiment of the present disclosure is executed.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function has been omitted when it is determined that it would otherwise interfere with the understanding of the embodiment of the present disclosure.

In describing the components of the embodiment according to the present disclosure, terms such as first, second, A, B, (a), (b), and the like may be used. These terms are merely intended to distinguish the components from other components and the terms do not limit the nature, order or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein. When a component, device, element, or the like of the present disclosure is described as having a purpose or performing an operation, function, or the like, the component, device, or element should be considered herein as being “configured to” meet that purpose or to perform that operation or function.

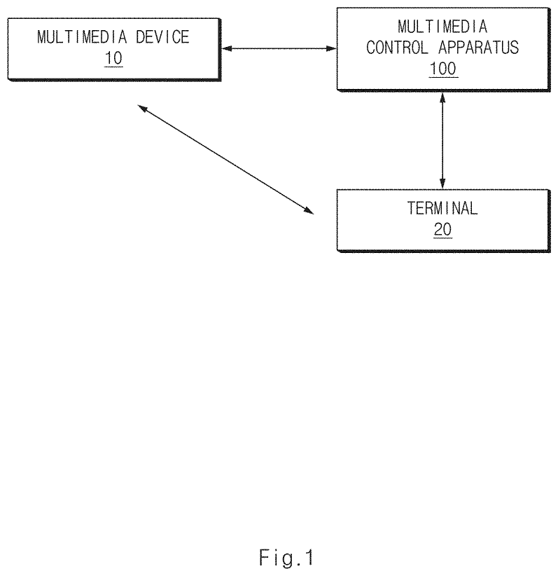

FIG. 1 is a diagram illustrating a vehicle system to which a multimedia control apparatus for a vehicle according to an embodiment of the present disclosure is applied.

Referring to FIG. 1, a vehicle system may include a multimedia control apparatus for a vehicle (hereinafter, referred to as a ‘multimedia control apparatus 100’).

The multimedia control apparatus 100 may control a mode of a multimedia device 10 in a vehicle. In particular, the multimedia control apparatus 100 may control the mode of a multimedia device located in the rear seat based on a rear seat passenger. For example, the multimedia control apparatus 100 may allow the multimedia device disposed at a seating position of the rear seat passenger to operate in a privacy mode.

An operation of the multimedia device located in the rear seat may be displayed on a monitor (hereinafter referred to as ‘rear seat monitor’) dedicated to rear seat passengers.

In this case, the multimedia device 10 may be implemented as the infotainment system of a vehicle.

The multimedia control apparatus 100 may scan an UWB (Ultra Wide Band) signal to identify whether a digital key approaches within a predetermined distance from the vehicle. When the digital key approaches within the predetermined distance, the multimedia control apparatus 100 may perform a user authentication through wireless communication with the digital key. In addition, the control apparatus 100 may detect a position of the authenticated digital key and then may predict a position of a boarding door before an occupant gets into the vehicle.

When authentication of the digital key is completed, the multimedia control apparatus 100 may activate sensors to search for a position of the occupant in the vehicle.

In addition, the multimedia control apparatus 100 may scan a terminal 20 of the occupant and may perform the user authentication using the retrieved terminal information. For example, the multimedia control apparatus 100 completes the authentication when the found terminal 20 is a previously registered user terminal.

The multimedia control apparatus 100 for the vehicle may control a mode operation of the rear seat multimedia device when the authenticated occupant is the rear seat passenger. In this case, the multimedia control apparatus 100 for the vehicle may identify a rear seat privacy mode setting of the authenticated user and may allow the rear seat multimedia device to operate in the privacy mode depending on the rear seat privacy mode setting.

The rear seat multimedia device may display information through the rear seat monitor. In this case, the rear seat monitor may be disposed on the left and right sides of the rear seat, respectively, and may also be disposed on the center of the rear seat. The arrangement structure of the rear seat monitor may be implemented in various ways according to a vehicle type or a vehicle specification.

For example, the rear seat monitor may be disposed on the rear of the backrest of the driver's seat and the passenger seat, respectively. However, this is only an example and is not limited thereto.

In this case, the multimedia control apparatus 100 according to the present disclosure may be implemented inside a vehicle. In this case, the multimedia control apparatus 100 may be integrally formed with the vehicle's internal control units. In another embodiment, the multimedia control apparatus 100 may be implemented as a separate device and may be connected to the vehicle's control units by a separate connection means. For example, the multimedia control apparatus 100 may be implemented in a form included in the multimedia device 10 in the vehicle or may be the multimedia device 10 itself.

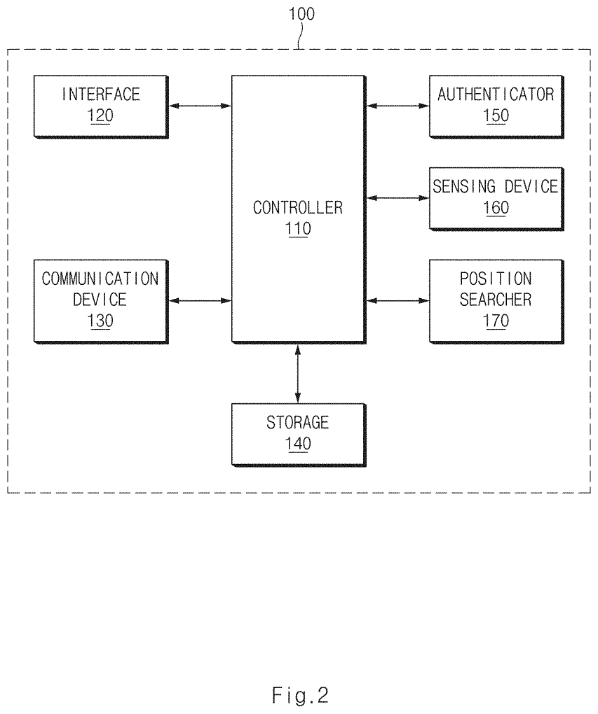

Therefore, the detailed configuration of the multimedia control apparatus 100 is described with reference to an embodiment of FIG. 2.

FIG. 2 is a diagram illustrating a configuration of a multimedia control apparatus for a vehicle according to an embodiment of the present disclosure.

Referring to FIG. 2, the multimedia control apparatus 100 may include a controller 110, an interface 120, a communication device 130, storage 140, an authenticator 150, a sensing device 160, and a position searcher 170. The controller 110 may control an operation of each component of the multimedia control apparatus 100 or may process a signal transferred among each component.

In this case, the controller 110, the authenticator 150, the sensing device 160, and the position searcher 170 of the multimedia control apparatus 100 according to the present embodiment may be implemented as at least one or more processors.

The interface 120 may include an input means for receiving a control command from a user and an output means for outputting an operation state and a result of the multimedia control apparatus 100. In this case, the input means and the output means of the interface 120 may be replaced with an input means and an output means of the multimedia device 10.

The input means may include a key button and may include a soft key implemented on the display. In addition, the input means may include a mouse, a joystick, a jog shuttle, a stylus pen, and the like.

The output means may include a display and may include an audio output means such as a speaker. As an example, the display may correspond to a front seat monitor and a rear seat monitor of the multimedia device 10.

In this case, when a touch sensor such as a touch film, a touch sheet, or a touch pad is provided in the display, the display operates as a touch screen and may be implemented in a form in which the input means and the output means are integrated.

In this case, the display may include at least one of a liquid crystal display (LCD), a thin film transistor-liquid crystal display (TFT LCD), an organic light-emitting diode (OLED), a flexible display, a field emission display (FED), or a three-dimensional display (3D display).

The communication device 130 may include a communication module for vehicle network communication with electric devices and/or controllers provided in the vehicle. As an example, the communication module may transmit a control signal to the multimedia device 10 or the rear seat monitor.

In this case, the vehicle network communication technology may include CAN (Controller Area Network) communication, LIN (Local Interconnect Network) communication, Flex-Ray communication, and the like.

In addition, the communication device 130 may include a communication module for wireless Internet access or a communication module for short range communication. As an example, the communication module may be wirelessly connected to the terminal 20 of the rear seat passenger and may transmit a signal of the rear seat multimedia device to the terminal 20 of the rear seat passenger according to a mode setting stored in the terminal 20. In addition, the communication module may transmit a signal corresponding to a user operation through the rear seat monitor to the terminal 20 of the rear seat passenger.

In this case, the wireless Internet technology may include a wireless IAN (WLAN), a Wireless Broadband (Wibro), a Wi-Fi, a World Interoperability for Microwave Access (Wimax), and the like.

In addition, the short range communication technology may include a Bluetooth, a ZigBee, an Ultra-Wideband (UWB), a Radio Frequency Identification (RFID), an infrared Data Association (IrDA), and the like.

The storage 140 may store data and/or algorithms required for the multimedia control apparatus 100 to operate.

As an example, the storage 140 may store setting information of multimedia devices in the vehicle. In addition, the storage 140 may store authentication information of a digital key registered in the vehicle and may store information of a previously registered user terminal. In addition, the storage 140 may store a list of terminals found inside the vehicle and/or position information thereof.

In addition, the storage 140 may store position search information of the occupant. As an example, the position search information may include open state information for each door position (i.e., each vehicle door), wireless signal search information for each seat position, and seating sensor detection information.

Also, the storage 140 may store a command and/or algorithm for searching for the rear seat passenger and controlling a mode of the rear seat monitor based on the rear seat passenger.

In this case, the storage 140 may include a storage medium such as a Random Access Memory (RAM), a Static Random Access Memory (SRAM), a Read-Only Memory (ROM), a Programmable Read-Only Memory (PROM), an Electrically Erasable Programmable Read-Only memory (EEPROM).

The authenticator 150 authenticates the UWB (Ultra Wide Band)-based digital key adjacent to the vehicle.

In this case, the communication device 130 scans the UWB (Ultra Wide Band) signal around the vehicle. When an access of the digital key is detected, the authenticator 150 performs user authentication of the digital key through wireless communication.

When the authentication of the digital key is completed, the position searcher 170 may detect the position of the authenticated digital key. In this case, the position searcher 170 may predict the position of the boarding door based on the detected position of the digital key. In this case, the position information of the boarding door may be used to predict the boarding position of the occupant.

The controller 110 may release a door lock when authentication of the digital key from the authenticator 150 is completed.

In addition, when the authentication of the digital key is completed, the controller 110 controls an operation of the sensing device 160 to detect occupants riding in the vehicle.

Accordingly, the sensing device 160 activates at least one sensor for detecting the vehicle occupant and detects the position of the vehicle occupant through the activated sensor. In this case, the sensing device 160 may control the sensor operation based on the position of the boarding door predicted based on the position of the digital key.

As an example, the sensor may include a door open detection sensor. The door open detection sensor is provided at a position where each door is disposed, for example, a driver's seat and a passenger seat of a vehicle, and a door on the left and right sides of the rear seat, respectively, to detect an open state of the corresponding door at the position of each door.

In this case, the door open detection sensor may be provided including as many as the number of doors. However, the number of doors may be increased or decreased according to the vehicle type and the vehicle specification.

The open state of the door may be stored in the storage 140 for each door.

For example, when the driver's door is defined as Dr1, the front passenger's door is defined as Dr2, the rear left door is defined as Dr3, and the rear right door is defined as Dr4, the open state of each door may be expressed as ‘0’ and ‘1’, such as “Dr1(1), Dr2(0), Dr3(0), Dr4(1)”. In this case, the open state of the door may be expressed as ‘1’ when the door is opened and ‘0’ when the door is not opened.

In addition, the sensor may further include a position detection sensor. The position detection sensor searches for the terminal 20 of the occupant located in the vehicle and, at this time, detects the found terminal list and position information of each terminal 20. As an example, the terminal list may include an address value of each terminal 20, a terminal name, and/or a supported communication method such as ultra-wide band (UWB), WiFi, Bluetooth (BT), and the like.

The position detection sensor may detect information of each terminal 20 located in the vehicle by using a short range communication technology, for example, the UWB communication technology. However, this is only one embodiment and various methods may be applied to the technology for detecting the position of each terminal 20 in the vehicle. The present disclosure is not limited thereto.

In this case, the position information of each terminal 20 may be detected corresponding to the position of each seat in the vehicle and may be stored in the storage 140.

For example, when the wireless detection position of the driver's seat is defined as Wp1, the wireless detection position of the passenger seat is defined as Wp2, the wireless detection position of the left rear seat is defined as Wp3, and the wireless detection position of the right rear seat is defined as Wp4, the position information of each terminal 20 may be expressed as ‘0’ and ‘1’, such as “Wp1(1), Wp2(0), Wp3(0), Wp4(1)”. In this case, it may be expressed as ‘1’ when the terminal 20 is detected at the seat position and expressed as ‘0’ when the terminal 20 is not detected at the corresponding seat position.

Also, the sensor may further include a seating sensor. The seating sensor is disposed on each seat in the vehicle and detects whether the occupant is seated.

The seating sensor may be provided as much as the number of each seats and the number of seats may be increased or decreased according to the vehicle type and the vehicle specification.

In this case, the seating sensor may include at least one or more of a sensor disposed at a lower end of each seat to detect a change in weight, a sensor disposed at the lower end or back of each seat to detect a temperature change, and/or a sensor to detect a belt fastener state at each seat position. In addition, the seating sensor may correspond to any sensor capable of detecting a state in which an occupant is seated on a seat, i.e., a seat seating state.

Seating detection information of the seating sensor may be detected corresponding to the position of each seat and may be stored in the storage 140.

For example, when the driver's seat position is defined as Sp1, the front passenger seat position is defined as Sp2, the rear left seat position is defined as Sp3, and the rear right seat position is defined as Sp4, the seating detection information for each seat position may be expressed as ‘0’ and ‘1’, such as “Sp1(1), Sp2(0), Sp3(0), Sp4(1)”. In this case, it may be expressed as ‘1’ when a seated position is detected at the corresponding seat position and expressed as ‘0’ when no seated position is detected at the corresponding seat position.

When the seating position detected by the sensing device 160 is stored in the storage 140, the authenticator 150 identifies the terminal list detected in the vehicle. In this case, the authenticator 150 performs user authentication by comparing the terminal information on the terminal list with information on the previously registered user terminal.

As an example, the authenticator 150 may complete the user authentication when the address value of the terminal 20 existing on the terminal list matches the address value of the previously registered user terminal.

The controller 110 allows a wireless connection with the user terminal authenticated by the authenticator 150. When a wireless connection with the user terminal is established, the controller 110 prepares a service to be provided to the user terminal.

As an example, the controller 110 may provide a Bluetooth hands-free service, a streaming service, a phone book service, a text service, and WiFi wireless connectivity (Carplay, Android Auto, CarLife, etc.) service to the wirelessly connected user terminal.

The controller 110 controls the operation of the position searcher 170 to determine the final position of the occupant when the user terminal is wirelessly connected.

Accordingly, the position searcher 170 determines the position of the occupant based on the location information of the wirelessly connected terminal 20 and the seat seating position detected by the seating sensor. The position searcher 170 may determine the position of the occupant by further considering the door open state of the vehicle doors.

For example, when the open state of the door is “Dr1(1), Dr2(0), Dr3(0), Dr4(1)”, the location information of the terminal 20 is “Wp1(1), Wp2(0), Wp3(0), Wp4(1)”, and the seat seating position is “Sp1(1), Sp2(0), Sp3(0), Sp4(1)”, the position searcher 170 may determine that the occupants are positioned to the driver's seat and the right side of the rear seat.

In contrast, when the open state of the door is “Dr1(1), Dr2(0), Dr3(0), Dr4(1)”, the location information of the terminal 20 is “Wp1(1), Wp2(0), Wp3(0), Wp4(1)”, and the seat seating position is “Sp1(1), Sp1(0), Sp3(1), Sp4(0)”, since the occupant may sit on the left seat of the rear seat after boarding using the rear right door, the position of the occupant may be determined by considering the seat seating position more preferentially than the open position of the door.

In addition, to increase an accuracy of the position, the position of the occupant may be determined by considering the seat seating position more preferentially than the detection position of the terminal 20.

Accordingly, when the open position of the door, the detected position of the terminal 20, and the seat seating position are different from each other, the position searcher 170 may prioritize the seat seating position to determine the position of the occupant.

Accordingly, the position searcher 170 may determine that the occupants are positioned on the driver's seat and the left side of the rear seat based on “Sp1(1), Sp2(0), Sp3(1), Sp4(0)”.

When the seat seating position is “Sp1(1), Sp2(0), Sp3(1), Sp4(1)”, the position searcher 170 may determine that the occupants are positioned on the driver's seat and the left and right sides of the rear seat, respectively.

When the position of the occupant is determined by the position searcher 170, the controller 110 determines whether a rear seat passenger exists based on the position of the occupant. When it is identified that the occupant is positioned on at least one of the left or right sides of the rear seat, the controller 110 may require a re-measurement for the position of the terminal 20 of the rear seat passenger to the position searcher 170 for the accuracy of position detection.

Accordingly, the position searcher 170 may re-measure the position of the terminal 20 based on the position of the rear seat passenger. In this case, when a re-detected position obtained by re-measuring the position of the terminal 20 is different from the previous detection position, the position searcher 170 may correct the pre-stored position information of the terminal 20 and may determine the final position of the occupant based thereon.

In this case, the position of the rear seat passenger may be any one of the rear seat left side, the rear seat right side, or the rear seat center.

When the final position of the rear seat passenger is identified through the position searcher 170, the controller 110 controls an operation of the rear seat multimedia device based on the finally identified position of the rear seat passenger.

When the final position of the occupant is the right side of the rear seat, the controller 110 may control the operation of the multimedia device disposed on the right side of the rear seat. Accordingly, the corresponding multimedia device operates under the control of the controller 110 and may display an operation screen of the multimedia device through the rear seat monitor.

In this case, the controller 110 identifies the setting state of the privacy mode stored in the terminal 20. The rear seat passenger may set the privacy mode in the terminal 20 in advance. Meanwhile, the rear seat passenger may manually set the privacy mode through the terminal 20 or a screen manipulation of the rear seat monitor depending on circumstances.

When the privacy mode is set to the ON state in the terminal 20, the controller 110 may allow the rear seat multimedia device disposed in the rear seat passenger position to operate in the privacy mode.

When there are passengers on the left and right sides of the rear seat, respectively, and both passengers have the privacy mode set to the ON state, the controller 110 may control the multimedia devices disposed on the left and right sides of the rear seat, respectively, to provide an independent privacy mode to each passenger in the rear seat.

In this case, since detailed operating conditions of the privacy mode may be set differently for each user, the rear seat multimedia devices may provide different privacy modes according to the conditions set by the authenticated user.

In addition, when there is no rear seat passenger, the privacy mode may not be provided.

In this case, the privacy mode is a mode for protecting a privacy for the personal information of the rear seat passenger, such that the content displayed on the rear seat monitor is disclosed only to the rear seat passenger to ensure independence.

For example, when an incoming call is received in the privacy mode set state, the rear seat multimedia device displays the call reception related content on the rear seat monitor of the corresponding passenger. In this case, a vehicle speaker may be switched to a mute state, or a call reception sound may not be output to the vehicle speaker.

When the passenger accepts the reception of a call (active call connection), the rear seat multimedia device may ensure independence by allowing a call connection to the terminal 20 through hands-free.

As another example, when a message is received in the privacy mode set state, the rear seat multimedia device displays the text reception content on the rear seat monitor of the passenger. In this case, the rear seat multimedia device may ensure independence by allowing the passenger to send a call to the terminal 20 through hands-free when the passenger requests to send a call to the text transmitter.

In addition, the rear seat multimedia device may prevent the information of the rear seat passenger from being exposed to other passengers in the privacy mode.

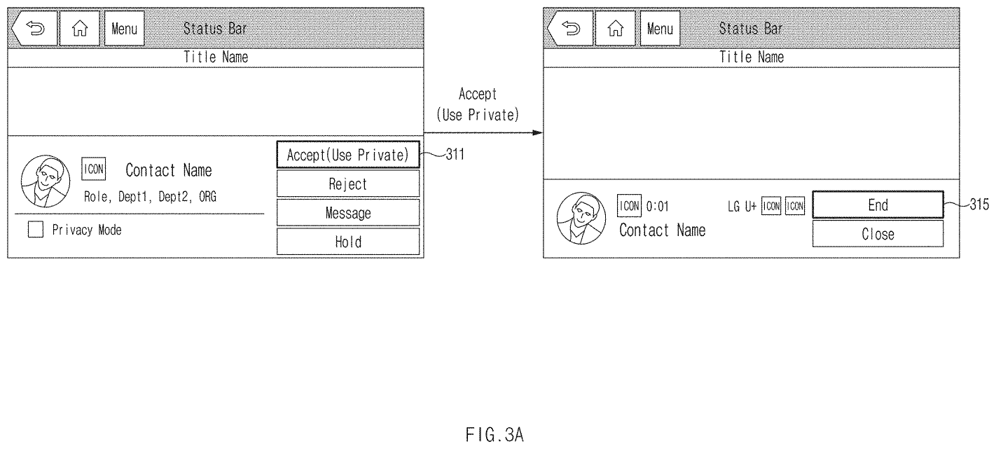

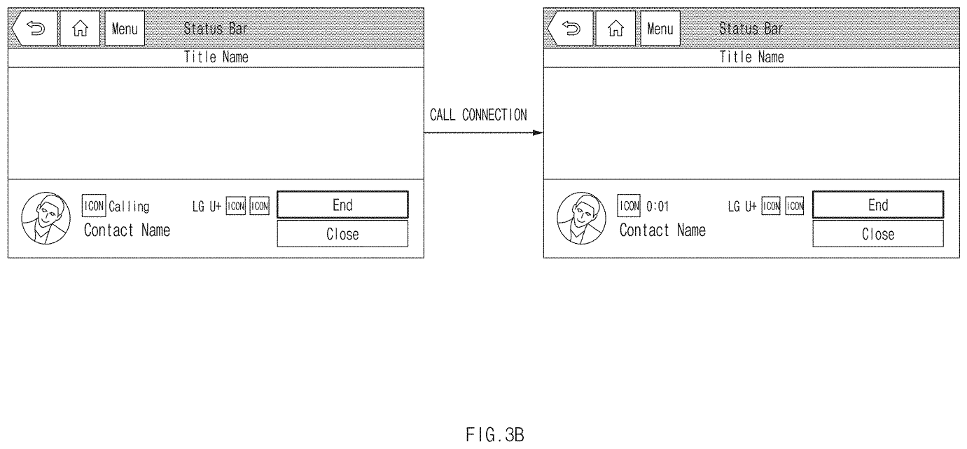

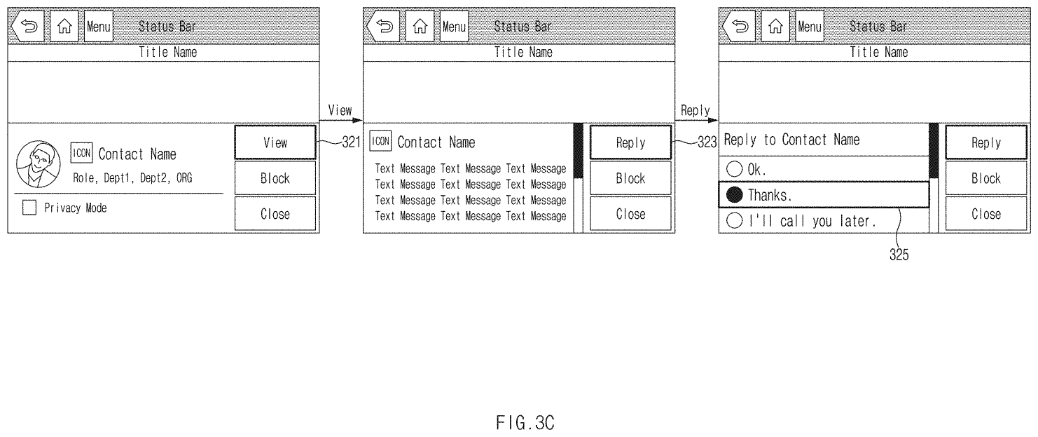

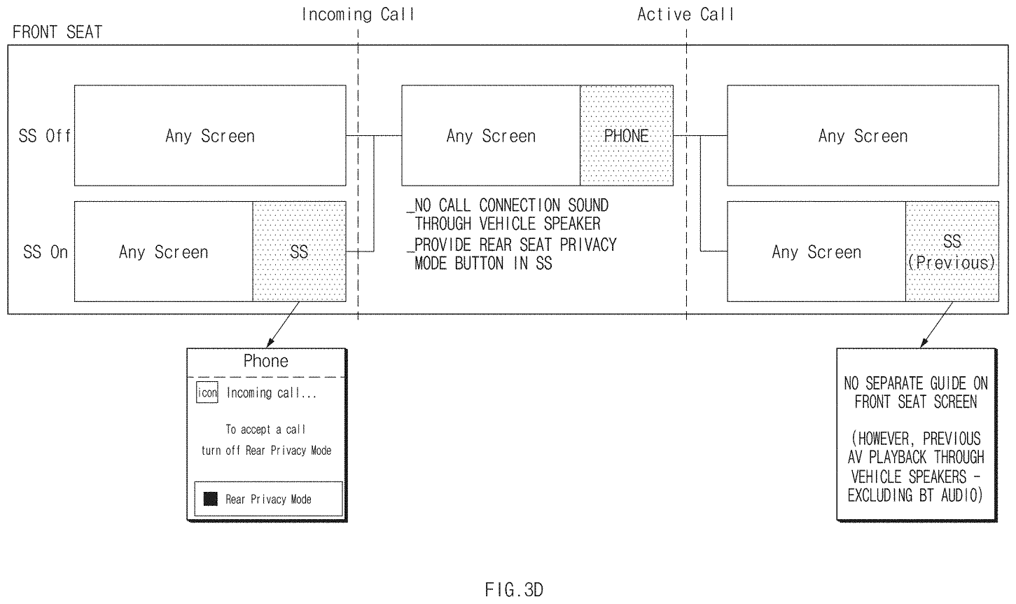

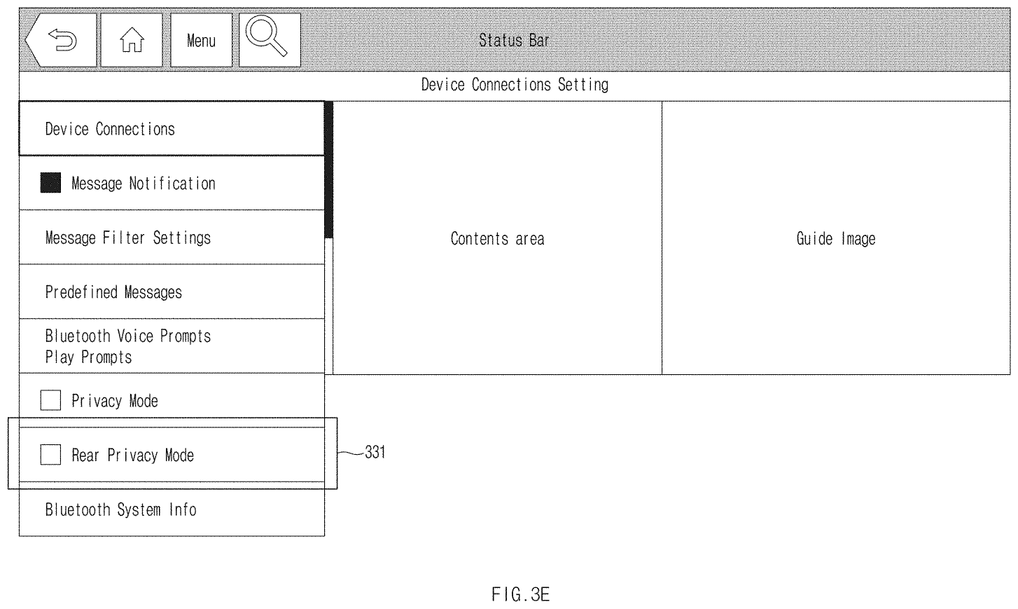

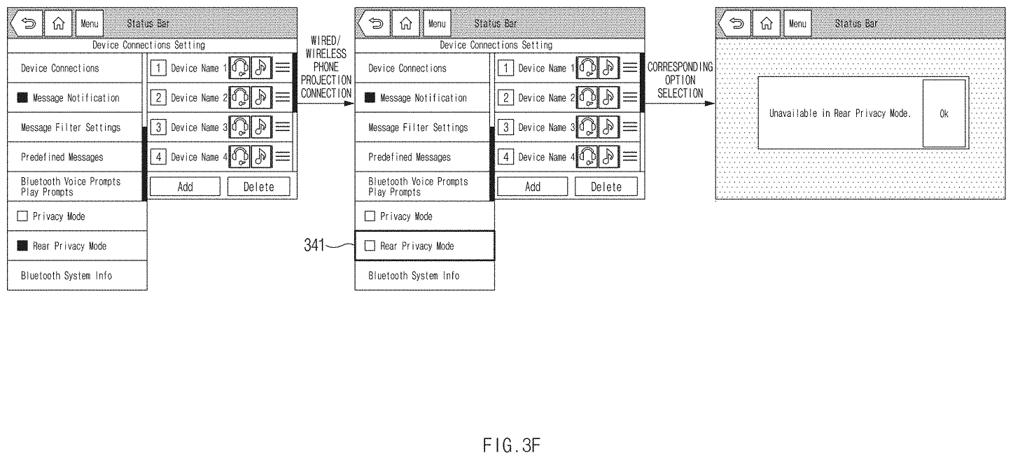

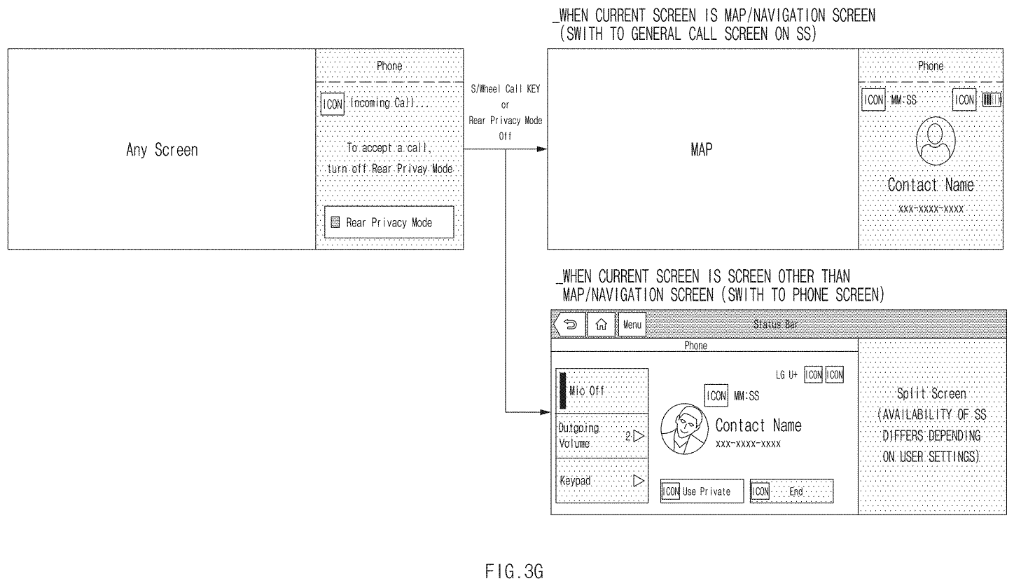

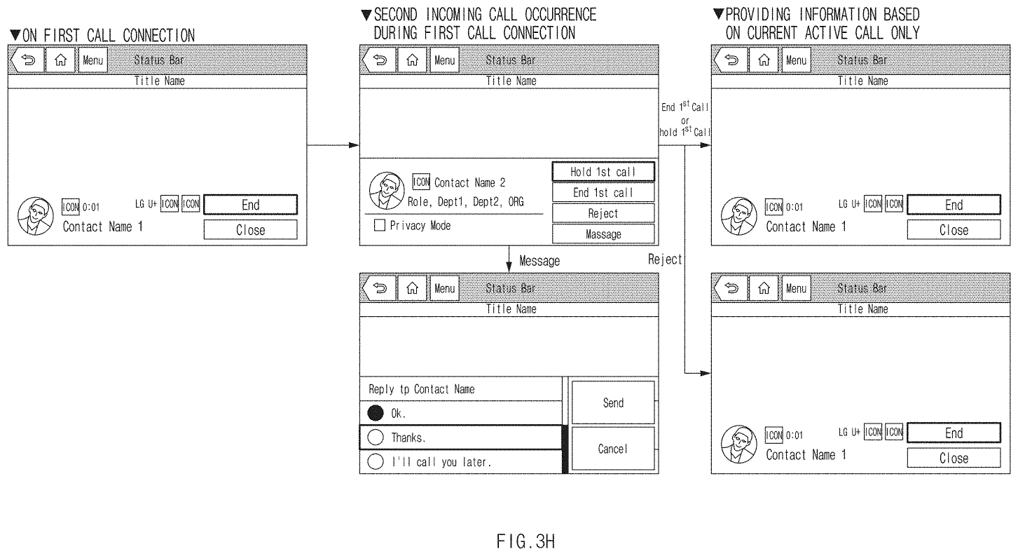

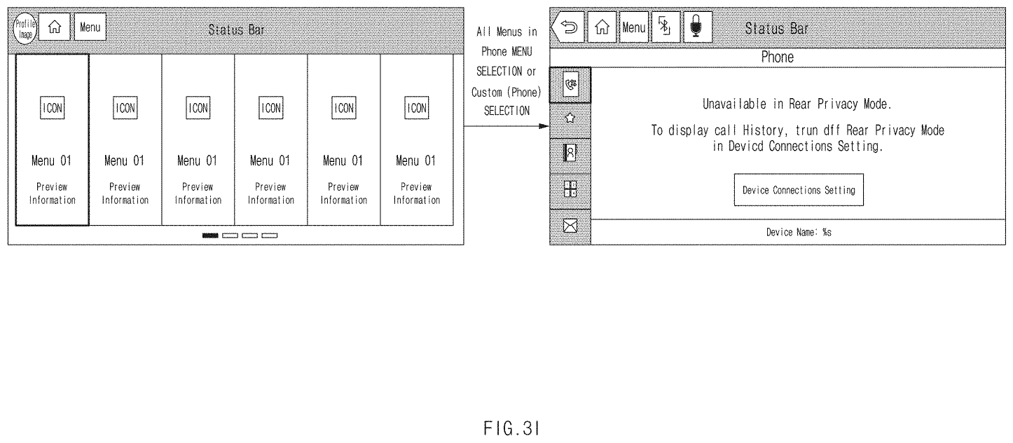

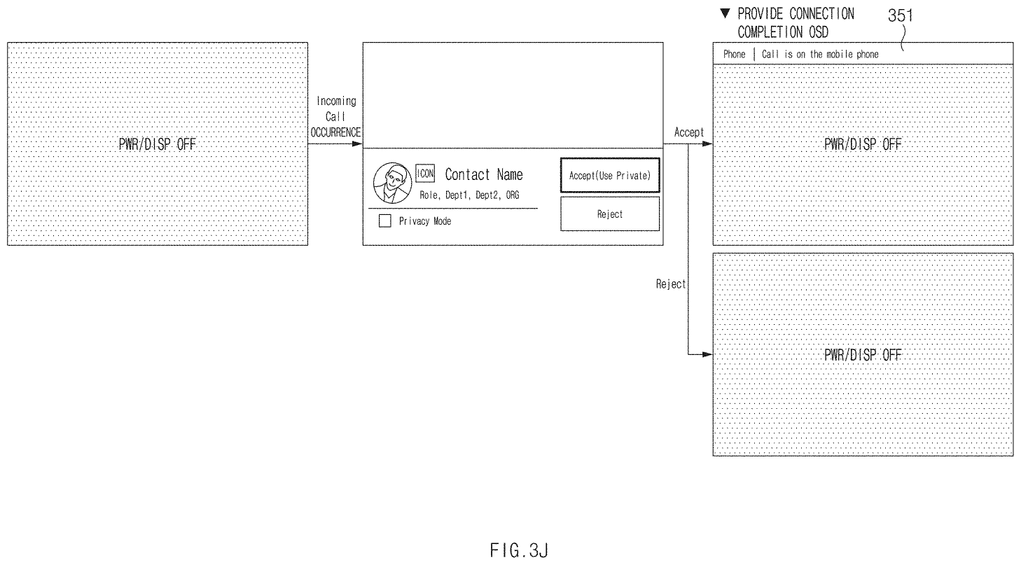

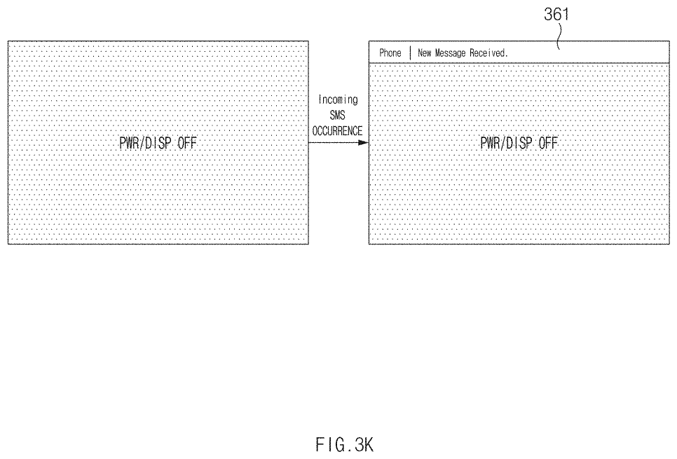

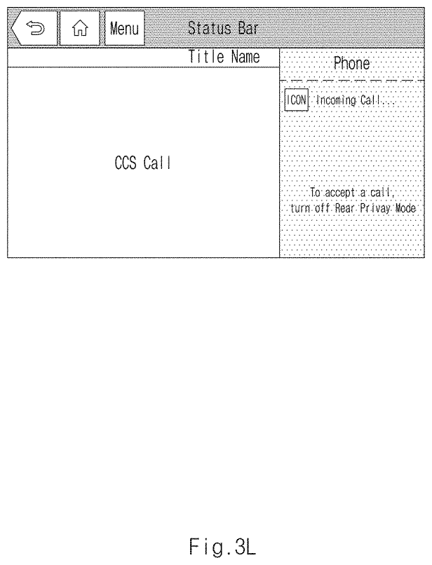

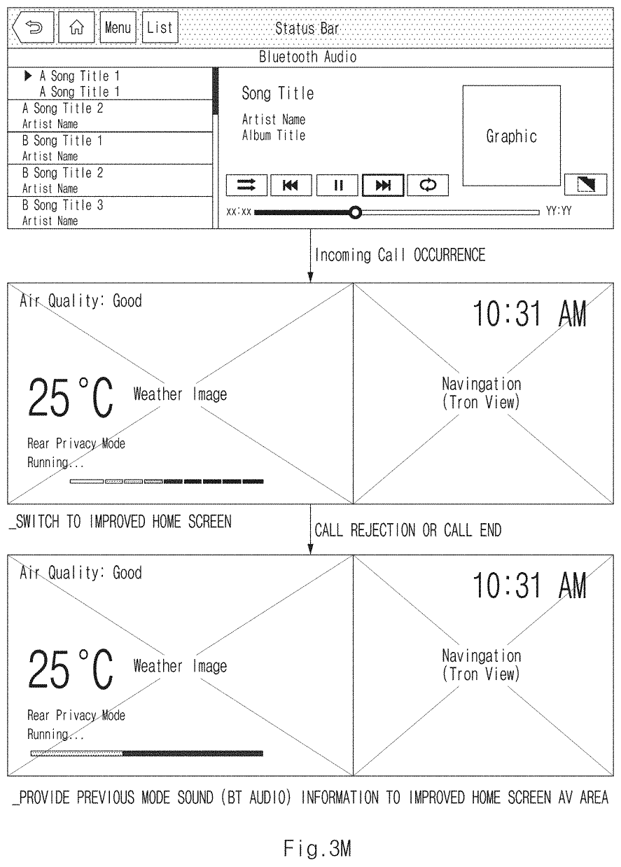

An embodiment of the privacy mode operation of the rear seat multimedia device is described with reference to FIGS. 3A-3L.

FIG. 3A illustrates a display screen of the rear seat monitor when the incoming call is received with the privacy mode set to ON.

Referring to FIG. 3A, when an incoming call is received in a state in which the privacy mode is set to ON, the multimedia device may display a call reception pop-up on the rear seat monitor. In this case, when a reception accept 311 is selected by the rear seat passenger, the multimedia device may display call connection information on the rear seat monitor. In this case, a reception sound may not be output through the vehicle speaker as the call is switched to the mobile phone through the hands-free. The rear seat passenger may end the call connection by selecting an End button 315 on the call connection screen.

FIG. 3B illustrates a display screen of the rear seat monitor when an outgoing call is received with the privacy mode set to ON.

Referring to FIG. 3B, the multimedia device may display a call outgoing pop-up on the rear seat monitor when the outgoing call is made with the privacy mode set to ON. In this case, when a call connection is established, the multimedia device may display call connection information through the rear seat monitor.

FIG. 3C illustrates a display screen of the rear seat monitor when an incoming message is received with the privacy mode set to ON.

Referring to FIG. 3C, the multimedia device may display a message reception pop-up on the rear seat monitor when the incoming message is received in a state in which the privacy mode is set to ON. In this case, when a view 321 is selected by the rear seat passenger, the message reception content may be displayed on the rear seat monitor. In this case, the rear seat passenger may select a Reply button 323 on the message reception content display screen. The multimedia device may display a message reply screen when the Reply button 323 on the message reception content display screen is selected. In this case, the multimedia device may provide recommended phrases and the rear seat passenger may select any one 325 of the recommended phrases to reply.

FIG. 3D illustrates a display screen of the front seat monitor when the incoming call is received with the privacy mode set to ON.

Referring to FIG. 3D, when a split screen (SS) of the front seat monitor is set to OFF, the multimedia device may minimize and provide PHONE-related information to the SS only when an active call is connected.

In contrast, when the SS of the front seat monitor is set to ON, the multimedia device may provide rear seat call related information to the SS when the incoming call occurs. In this case, an On/Off setting button of the rear seat privacy mode may be displayed together.

The multimedia device provides the minimized PHONE-related information to the SS when the active call is connected with the privacy mode set to ON, but may prevent the call sound from being output to the vehicle speaker.

When the call is ended, the multimedia device allows an operation before the call connection to be performed without a separate guide to the SS of the front seat monitor.

FIG. 3E illustrates a privacy mode setting screen.

Referring to FIG. 3E, the multimedia device provides an On/Off selection option 331 of a rear seat privacy mode in a device connections settings menu. In this case, the user may set a privacy mode On/Off by selecting or deselecting a check box of the On/Off selection option 331 of the rear seat privacy mode.

FIG. 3F illustrates a screen when a front seat phone projection is connected with the privacy mode set to ON.

Referring to FIG. 3F, when the rear seat privacy mode is set to ON and the phone projection is connected from the front seat, the multimedia device may forcibly switch the rear seat privacy mode to an Off state.

In this case, when the user selects a privacy mode ON setting option, the multimedia device may provide an unavailable pop-up through the rear seat monitor.

In this case, a separate notification pop-up may not be provided to the rear seat monitor when an Incoming Call/short message service (SMS) occurs in a connection state of a front seat wired/wireless phone projection.

FIG. 3G illustrates an operation screen when a front seat user performs a steering wheel call operation with the privacy mode set to ON.

Referring to FIG. 3G, when the front seat user executes the steering wheel call operation in a state in which the rear seat privacy mode is set to ON, the multimedia device may display a general call connection screen on the SS when the current screen is a map/navigation screen.

In contrast, when the front seat user executes the steering wheel call operation in the state in which the rear seat privacy mode is set to ON, the multimedia device may display a Phone screen on the front seat monitor when the current screen is a screen other than the map/navigation screen. In this case, the SS may not be provided based on a user's settings.

FIG. 3H illustrates a screen when a second incoming call occurs during a first call connection with the privacy mode set to ON.

Referring to FIG. 3H, when the second incoming call occurs during the first call connection, the multimedia device may provide a second incoming call reception pop-up to the rear seat monitor.

In this case, the user may select any one function of a reception after a call ends, a reception after waiting, a rejection, or a message. Accordingly, the multimedia device may switch the rear seat monitor screen to the 2nd call connection screen, may maintain the 1st call connection screen as it is, or switch to the message sending screen for the 2nd incoming call according to the user's selection.

However, unlike the front seat monitor screen, the multimedia device may only provide the current active call information, without displaying both the 1st call and the 2nd call, on the rear seat monitor screen.

FIG. 3I illustrates a display screen when entering a Phone screen with the privacy mode set to ON.

Referring to FIG. 3I, when the rear seat privacy mode is set to ON and a Phone screen entry menu is selected, the multimedia device may block entry to the Phone screen and may provide an unavailable message for the corresponding menu.

FIG. 3J illustrates an operation screen when an incoming call occurs in a rear seat power/display (PWR/DISP) Off state with the privacy mode set to ON.

Referring to FIG. 3J, when the incoming call occurs in the rear seat PWR/DISP Off state, the multimedia device allows the incoming call pop-up to be only displayed while the PWR/DISP Off state is maintained. In this case, when reception accept is selected by the user, the multimedia device maintains the PWR/DISP Off state again and allows minimal information to be only provided through an on-screen display (OSD) 351.

FIG. 3K illustrates an operation screen when an incoming SMS occurs in the rear seat PWR/DISP Off state with the privacy mode set to ON.

Referring to FIG. 3K, when the incoming SMS occurs in the rear seat PWR/DISP Off state, the multimedia device provides only new message reception information through an OSD 361 while maintaining the PWR/DISP Off state.

FIG. 3L illustrates an operation screen when a rear seat BT incoming call occurs during a front seat common-channel signaling (CCS) call with the privacy mode set to ON.

Referring to FIG. 3L, when the rear seat BT incoming call occurs during the front seat CCS call with the rear seat privacy mode set to ON, the multimedia device may guide only the incoming call reception situation through the SS while maintaining the CCS call screen of the front seat monitor

However, the incoming call reception pop-up may be provided to the rear seat monitor regardless of the CCS call situation.

FIG. 3M illustrates an operation screen when an incoming call occurs in a BT Audio screen with the privacy mode set to ON.

Referring to FIG. 3M, when the privacy mode is set to ON, and the incoming call occurs on the BT Audio screen, the multimedia device may switch the BT Audio screen to a home screen when and may provide only minimal incoming call information.

When the incoming call is rejected or ended after the call is connected, the multimedia device may play the sound of the BT Audio, i.e., the previous mode operation while maintaining the home screen.

The multimedia control apparatus 100 for the vehicle according to this embodiment operating as described above may be implemented in the form of an independent hardware device including a memory and a processor for processing each operation and may be driven in a form included in another hardware device such as a microprocessor or a general-purpose computer system.

An operation flow of an apparatus according to the present disclosure configured as described above is described in more detail as follows.

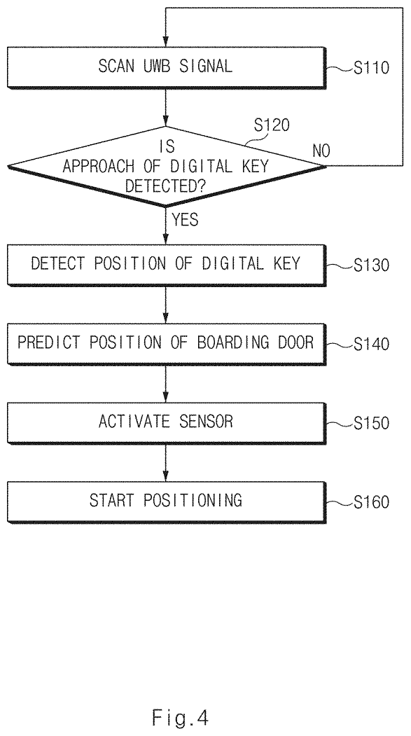

FIGS. 4, 5, and 6 are diagrams illustrating an operation flow for a multimedia control method for a vehicle according to an embodiment of the present disclosure.

FIG. 4 illustrates a preparation operation before searching for an occupant in a multimedia control apparatus for a vehicle according to an embodiment of the present disclosure.

Referring to FIG. 4, the multimedia control apparatus 100 scans the UWB signal to detect a digital key approaching within a predetermined distance from the vehicle (S110).

When the approach of the digital key is detected within the predetermined distance from the vehicle (S120), the multimedia control apparatus 100 authenticates the digital key through wireless communication and detects the position of the authenticated digital key (S130).

In this case, the multimedia control apparatus 100 may predict the position of the boarding door based on the position of the digital key (S140).

When the authentication of the digital key is completed, the multimedia control apparatus 100 activates at least one or more sensors to search for a vehicle occupant (S150), and in this case, starts positioning through the activated at least one or more sensors (S160).

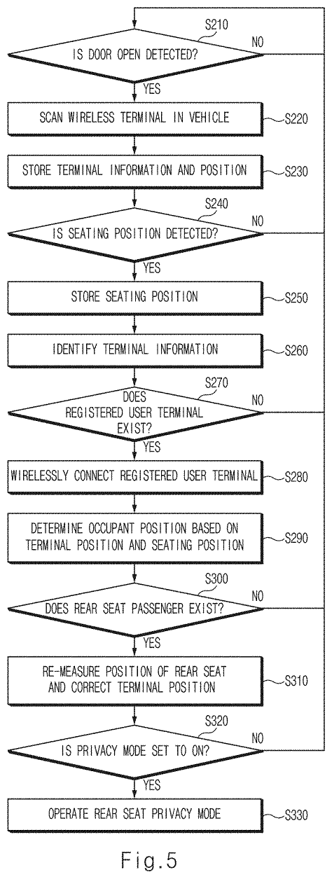

When the preparation operation is completed through the processes of FIG. 4, the multimedia control apparatus 100 performs the processes of FIG. 5.

FIG. 5 illustrates an operation of providing a privacy mode based on a position of a rear seat passenger in the multimedia control apparatus for a vehicle according to an embodiment of the present disclosure.

Referring to FIG. 5, the multimedia control apparatus 100 identifies whether the door open state of the vehicle is detected based on sensor detection information (S210). In this case, the door open state may be detected by using a door open detection sensor disposed on each door.

In this case, when the door open state of the vehicle is detected, the multimedia control apparatus 100 scans the terminal 20 located in the vehicle by using wireless communication (S220). In this case, the terminal 20 may correspond to a wireless terminal possessed by the vehicle occupant, for example, a smartphone, a tablet PC, a smart watch, and the like.

The multimedia control apparatus 100 stores the terminal list and position information detected in S220 (S230). In this case, the multimedia control apparatus 100 may detect the position of each terminal 20 by using the short range communication technology, for example, the UWB communication technology. However, this is only one embodiment, various methods may be applied to the technology for detecting the position of the terminal 20 in the vehicle, and it is not limited to any one method or technology.

In addition, the multimedia control apparatus 100 may detect a seating position and store the detected seating position (S250) when a seating state of a vehicle occupant is detected using a seating sensor (S240).

Thereafter, the multimedia control apparatus 100 identifies the information of the terminal 20 included in the terminal list stored in S230 (S260). In this case, the multimedia control apparatus 100 may compare the information of the terminal 20 with the previously registered user terminal information.

The multimedia control apparatus 100, when it is identified that the terminal 20 included in the terminal list is a previously registered user (S270), wirelessly connects the user terminal (S280). When the terminal 20 included in the terminal list is not a previously registered user terminal, the multimedia control apparatus 100 may not wirelessly connect the terminal 20.

When the user terminal is wirelessly connected, the multimedia control apparatus 100 determines the position of the occupant based on the position information of the corresponding terminal 20 stored in S230 and the seating position information stored in S250 (S290). In this case, the multimedia control apparatus 100 may additionally consider the position information at which the door open is detected in S210.

When it is identified that the rear seat passenger exists through S290 (S300), the multimedia control apparatus 100 re-measures the terminal 20 located in the rear seat based on the identified position of the rear seat passenger, and then when the result of re-measurement of the position of the rear seat terminal is different from the position of the terminal 20 identified in S230, corrects the stored position of the terminal 20 (S310).

The multimedia control apparatus 100 may identify the final position of the rear seat passenger and may control the operation of the rear seat multimedia device based on the position of the rear seat passenger.

In this case, the multimedia control apparatus 100 identifies the privacy mode setting stored in the terminal 20 of the rear seat passenger. The privacy mode may be stored as setting information in the user terminal in advance and may be manually set by the rear seat passenger when it is not stored in advance.

When the privacy mode is set to ON (S320), the multimedia control apparatus 100 allows the rear seat multimedia device to operate in the privacy mode based on the position of the rear seat passenger (S330). Accordingly, the rear seat multimedia device may operate in the privacy mode and may display the operating state on the rear seat monitor.

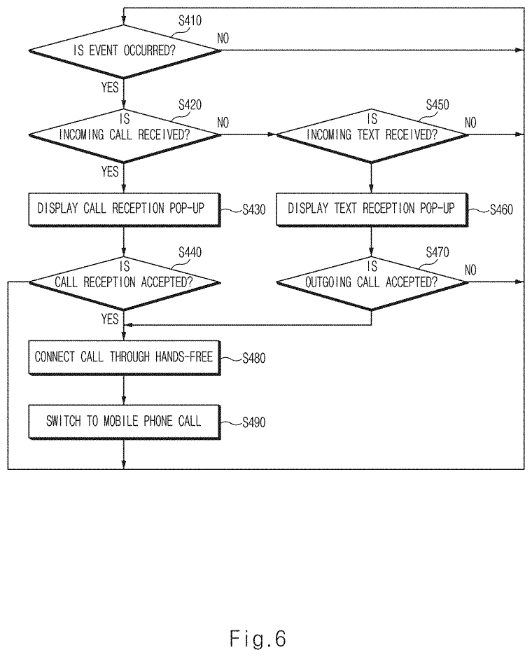

An embodiment of the privacy mode operation of the rear seat multimedia device is described with reference to FIG. 6.

Referring to FIG. 6, when an incoming call event occurs (S410, S420), the rear seat multimedia device displays a call reception pop-up through the rear seat monitor installed at the rear seat passenger position (S430). In this case, the rear seat multimedia device may prevent the incoming call sound from being output to the vehicle speaker.

In this case, the rear seat passenger may select whether to receive a call through the call reception pop-up displayed on the rear seat monitor. When the rear seat passenger selects the incoming call accept (S440), the rear seat multimedia device connects the call through the hands-free to prevent the call sound from being output to the outside (S480) and may switch the user terminal connection to a mobile phone call state (S490).

In contrast, when an incoming text event occurs (S410, S450), the rear seat multimedia device displays a text reception pop-up through the rear seat monitor installed at the rear seat passenger position (S460).

In this case, the rear seat passenger may select whether or not to make an outgoing call through the text reception pop-up displayed on the rear seat monitor. When the rear seat passenger selects to make the outgoing call in the text reception pop-up (S470), the rear seat multimedia device may connect the call through the hands-free to prevent the call sound from being output to the outside (S480) and may switch the user terminal connection to the mobile phone call state (S490).

The operation of FIG. 6 illustrates an embodiment, and the rear seat multimedia device may provide various types of privacy modes depending on services provided by the corresponding multimedia device.

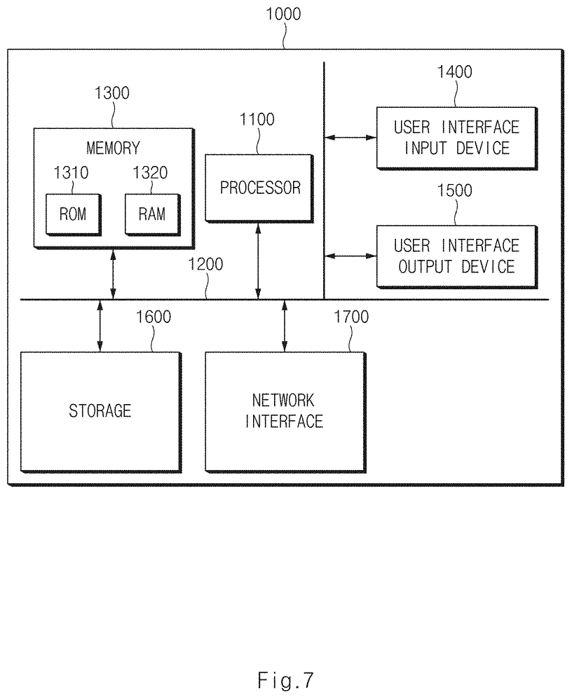

FIG. 7 is a diagram illustrating a computing system in which a method according to an embodiment of the present disclosure is executed.

Referring to FIG. 7, a computing system 1000 includes at least one processor 1100, a memory 1300, a user interface input device 1400, a user interface output device 1500, storage 1600, and a network interface 1700, which are connected through a bus 1200.

The processor 1100 may be a central processing unit (CPU) or a semiconductor device that executes processing on instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the method or the steps of algorithm described in connection with the embodiments disclosed herein may be implemented directly in hardware, a software module, or a combination of the two, which is executed by the processor 1100. The software module may reside in a storage medium (i.e., the memory 1300 and/or the storage 1600) such as a RAM, a flash memory, a ROM, an EPROM, an EEPROM, a register, a hard disk, a removable disk, and a CD-ROM. A storage medium is coupled to the processor 1100, the processor 1100 may read information from and write information to the storage medium. Alternatively, the storage medium may be integrated with the processor 1100. The processor and storage medium may reside within an application specific integrated circuit (ASIC). The ASIC may reside within the user terminal. Alternatively, the processor and storage medium may reside as separate components within the user terminal.

According to an embodiment of the present disclosure, the privacy of rear seat passengers may be prevented from being leaked to other occupants and the independence may be provided, by controlling an operation of the multimedia device dedicated to the rear seat in the privacy mode based on the rear seat passenger.

The above description is merely illustrative of the technical idea of the present disclosure. Those of ordinary skill in the art to which the present disclosure pertains should be able to make various modifications and variations without departing from the essential characteristics of the present disclosure.

Accordingly, the embodiments disclosed in the present disclosure are not intended to limit the technical idea of the present disclosure, but to explain the technical idea. The scope of the technical idea of the present disclosure is not limited by these embodiments. The scope of protection of the present disclosure should be interpreted by the following claims and all technical ideas within the scope equivalent thereto should be construed as being included in the scope of the present disclosure.

What is claimed is:

1. A multimedia control apparatus for a vehicle, the multimedia control apparatus comprising:
a sensing device configured to detect a terminal position and a seat seating position in the vehicle when an open door of the vehicle is sensed;
a position searcher configured to determine a position of a rear seat passenger based on the terminal position and the seat seating position; and
a controller configured to control a privacy mode operation of a rear seat multimedia device based on the position of the rear seat passenger.

2. The multimedia control apparatus of claim 1, further comprising:
an authenticator configured to authenticate the terminal by comparing the terminal information with information of a previously registered user terminal, and
wherein the sensing device includes a sensor configured to scan a terminal in the vehicle using a wireless communication method and to detect at least one or more terminal information and position information.

3. The multimedia control apparatus of claim 2, wherein the controller allows the rear seat multimedia device to operate in a privacy mode based on setting of the privacy mode stored in the terminal, when the authentication of the terminal is completed.

4. The multimedia control apparatus of claim 2, wherein the controller allows the rear seat multimedia device to operate in a privacy mode based on setting of the privacy mode input through the terminal or a monitor of the rear seat multimedia device, when the authentication of the terminal is completed.

5. The multimedia control apparatus of claim 1, wherein the sensing device includes at least one or more of a sensor disposed at a lower end of each seat to detect a change in weight, a sensor disposed at the lower end or a back of each seat to detect a temperature change, a sensor to detect a belt fastener state at each seat position, or a sensor to detect a state of the open door of the vehicle, and
wherein the position searcher determines the position of the rear seat passenger based on the terminal position, the seat seating position, and a position of the open door.

6. The multimedia control apparatus of claim 5, wherein the controller determines the position of the rear seat passenger based on a priority of each position, when at least one or more of the terminal position, the seat seating position, or the position of the open door is different.

7. The multimedia control apparatus of claim 6, wherein the controller determines the position of the rear seat passenger by preferentially considering the seat seating position among the terminal position, the seat seating position, and the position of the open door.

8. The multimedia control apparatus of claim 1, wherein the position searcher re-measures the terminal position based on the position of the rear seat passenger when the position of the rear seat passenger is determined, and updates the terminal position when the re-measured terminal position is different from a previously detected terminal position.

9. The multimedia control apparatus of claim 8, wherein the position searcher determines a final position of the rear seat passenger based on the updated terminal position.

10. The multimedia control apparatus of claim 1, wherein the position searcher detects a position of a digital key to predict an open position of a boarding door, when an approach of the digital key is detected within a predetermined distance from the vehicle.

11. The multimedia control apparatus of claim 1, wherein the rear seat multimedia device displays call receiving information on a rear seat monitor at the position of the rear seat passenger without outputting an incoming call sound through a vehicle speaker when an incoming call is received in a setting state of a privacy mode, and connects a call to the terminal of the rear seat passenger through hands-free when an active call is connected, and
wherein the controller limits operation information of the rear seat multimedia device, which is displayed on a monitor of a front seat multimedia device, when the rear seat multimedia device operates in a privacy mode.

12. The multimedia control apparatus of claim 11, wherein the controller releases the privacy mode of the rear seat multimedia device, when a phone projection connection is performed through the front seat multimedia device while the rear seat multimedia device operates in the privacy mode.

13. A multimedia control method for a vehicle comprising:
detecting a terminal position and a seat seating position in the vehicle when an open door of the vehicle is sensed;
determining a position of a rear seat passenger based on the terminal position and the seat seating position; and
controlling a privacy mode operation of a rear seat multimedia device based on the position of the rear seat passenger.

14. The multimedia control method of claim 13, wherein the detecting includes:
scanning a terminal in the vehicle using a wireless communication method and detecting at least one or more terminal information and position information.

15. The multimedia control method of claim 14, further comprising:
authenticating the terminal by comparing the terminal information with information of a previously registered user terminal.

16. The multimedia control method of claim 15, wherein the controlling allows the rear seat multimedia device to operate in a privacy mode based on setting of the privacy mode, when an authentication of the terminal is completed.

17. The multimedia control method of claim 13, wherein, the detecting includes detecting the seat seating position based on at least one or more of a change in weight, a temperature change, or a belt fastener state, at each seat position.

18. The multimedia control method of claim 13, wherein the determining includes determining the position of the rear seat passenger based on the terminal position, the seat seating position, and a position of the open door of the vehicle.

19. The multimedia control method of claim 13, further comprising:
re-measuring the terminal position based on the position of the rear seat passenger when the position of the rear seat passenger is determined, and updating the terminal position when the re-measured terminal position is different from a previously detected terminal position; and
determining a final position of the rear seat passenger based on the updated terminal position.

20. The multimedia control method of claim 13, further comprising:
detecting an approach of a digital key within a predetermined distance from the vehicle; and
detecting a position of the digital key when the approach of the digital key is detected and predicting an open position of a boarding door.
